(19) United States
(12) Patent Application Publication
(10) Pub. No.: US 2024/0370742 A1
(43) Pub. Date: Nov. 7, 2024

(54) SYSTEMS AND METHODS FOR EVENT PREDICTION

(71) Applicant: Olo Inc., New York, NY (US)

(72) Inventors: Kenneth David Marks, Towaco, NJ (US); Mingming Zhang, Ann Arbor, MI (US); Michael Hecheng Wang, Chicago, IL (US); Isaac Thomas Lacey, Lynchburg, VA (US); Emil Jeffrey Narciso, Brooklyn, NY (US); Nathan Henjes, Gainesville, FL (US); Nicholas Tholin, Rockton, IL (US)

(21) Appl. No.: 18/540,353

(22) Filed: Dec. 14, 2023

Related U.S. Application Data
(60) Provisional application No. 63/464,425, filed on May 5, 2023.

(51) Int. Cl. G06N 5/022

(52) U.S. Cl. CPC G06N 5/022

(57) ABSTRACT

In an aspect, a method of event prediction using a predictive process is presented. The method includes receiving, at a computing device, a digital request from an order management system of an entity. The method includes obtaining, by the computing device, at least a property of the digital request, wherein the property includes a time to complete the digital request. The method includes inputting, by the computing device, the property into the predictive process. The predictive process utilizes an extreme gradient boosting function and is trained to input properties and output prediction events through at least an iteration of a training phase of the extreme gradient boosting function. The method includes generating, from the predictive process, a prediction event including a period of time. The prediction event is indicative of a time to complete the digital request.

### CROSS-REFERENCE TO RELATED APPLICATIONS

This application claims priority to, and the benefit of, U.S. Provisional App. No. 63/464,425, titled “SYSTEMS AND METHODS FOR DETERMINING ORDER PREPARATION TIME USING MACHINE LEARNING MODELS,” filed on May 5, 2023, the entirety of which is incorporated herein by reference.

### TECHNICAL FIELD

The present disclosure generally relates to machine learning technology and/or processes, and, more particularly, to systems and computer-implemented methods for event prediction using machine learning technology and/or processes.

### BACKGROUND

Event prediction analysis is a complex computational field in which a relatively large number of factors may be considered in analyzing and/or generating predictions of events. Typically, prediction analysis may be structured to follow a hierarchical processing in determining one or more possible outcomes. These or like approaches, however, may rely on feature-level modeling as part of machine learning and/or subsequent deployment in the overall prediction process.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 illustrates an example system environment for event prediction in the context of order preparation time, in accordance with an embodiment.

FIG. 2 is a block diagram illustrating example computer logic components of an event prediction system, in accordance with an embodiment.

FIG. 3A is a flow diagram illustrating an example machine learning process for event prediction, in accordance with an embodiment.

FIG. 3B is a flow diagram illustrating an example process for developing a machine learning process for event prediction, in accordance with an embodiment.

FIG. 4A is a flow diagram illustrating a deployment of a machine learning process for event prediction, in accordance with an embodiment.

FIG. 4B is a flow diagram illustrating another example process for developing a machine learning process for event prediction, in accordance with an embodiment.

FIG. 5 illustrates an example computer system for implementing systems and methods for event prediction, in accordance with an embodiment.

FIG. 6 illustrates an example customer order management system, in accordance with an embodiment.

FIGS. 7-8 illustrate example performance of trained machine learning processes for event prediction in the context of predicting order preparation time, in accordance with an embodiment.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others, one or more aspects, properties, etc. may be omitted, such as for ease of discussion, or the like. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers at least to the context of the present patent application.

As alluded to previously, disclosed herein are systems and methods that may be used, in whole or in part, to electronically analyze and/or generate predictions of one or more events, such as in connection with machine learning technology and/or processes. For example, in some instances, these or like one or more systems and methods may be implemented, in whole or in part, to facilitate and/or support determining or predicting order preparation time (e.g., lead time), though subject matter should not be so limited. As discussed in greater detail below, in one or more embodiments, one or more systems and methods described herein may involve generating predicted order preparation time by implementing one or more machine learning processes, such as via analyzing a set of properties associated with an electronically obtained and/or communicated customer order. In some instances, these or like properties, including characteristics of the customer order and real-time conditions, for example, alone or in combination, may affect or influence an order preparation time. One or more methods and systems described herein provide an improved performance in prediction by analyzing these properties, together or in any suitable combination, as will also be seen.

Advantageously, in addition to more accurate event prediction, one or more machine learning approaches described herein may facilitate and/or support electronic processing and/or analysis of relatively large amounts of computer-readable input data (e.g., over 1000 properties for an order, etc.) that may otherwise be too large or computationally complex to be determined by traditional data-processing tools, so as to provide more efficient operations. As a way of illustration, this or like improved accuracy and/or efficiency may help a service entity, such as a restaurant, for example, to improve satisfaction of customers and/or delivery couriers, maintain order quality, manage capacity efficiently, optimize service operations, etc., among other benefits.

In an aspect, one or more embodiments of the present disclosure feature a computer-implemented method, such as applied for predicting order preparation time using a machine learning process. In some instances, a method may include, for example, receiving a set of respective properties for a plurality of historical customer orders associated with a food service entity, and training a machine learning process, such as using the set of properties to predict a lead time for providing a new customer order associated with the food service entity. A set of properties for a historical customer order may comprise, for example, a set of characteristics of the historical customer order, a set of real-time conditions relating to the historical customer order, a lead time for providing the historical customer order, etc. among others, as will be seen.

In an embodiment, a food service entity may include, for example, a restaurant at a particular geographical location.

In an embodiment, a food service entity may include, for example, a plurality of restaurants of a particular brand at a plurality of different geographical locations.

In an embodiment, a set of characteristics of a historical customer order may include, for example, one or more types of items in the historical customer order and/or a number of items in the historical customer order.

In an embodiment, a set of characteristics of a historical customer order may include, for example, one or more modifications to one or more items in the historical customer order and/or an indication of whether the historical customer order was scheduled for a future time.

In an embodiment, a set of real-time conditions relating to the historical customer order may include, for example, a queue position of the historical customer order relative to one or more other historical customer orders.

In an embodiment, a set of real-time conditions relating to a historical customer order may include, for example, a location where the historical customer order was fulfilled, a day of the week during which the historical customer order was placed or fulfilled, a time of placing the historical customer and/or time of order fulfillment, weather conditions at the time of placing the historical customer order and/or time of order fulfillment, etc.

In an embodiment, training a machine learning process may include, for example, electronically providing at least a first portion of one or more sets of properties for a plurality of historical customer orders as input to a gradient boosting algorithm.

In an embodiment, training a machine learning process may further include, for example, minimizing a mean squared error loss function.

In an embodiment, training a machine learning process may further include, for example, validating the machine learning process using at least a second (e.g., different, etc.) portion of one or more sets of properties for a plurality of historical customer orders.

In another aspect, one or more embodiments of the present disclosure feature a computer-implemented method for predicting order preparation time using a machine learning process. A method can include, for example, receiving a customer order for a food service entity; providing as input to a machine learning process a set of properties associated with the customer order, and receiving as output from the machine learning process a predicted lead time for providing the customer order. A set of properties can include, for example, a set of characteristics of a customer order and a set of real-time conditions relating to the customer order. A machine learning process may be trained to predict lead times for providing customer orders associated with a food service entity, such as using one or more characteristics of historical customer orders, real-time conditions relating to the historical customer orders, lead time for providing the historical customer orders, and/or one or more other suitable aspects.

In an embodiment, a method may include, for example, establishing an electronic connection to a customer order management system of a food service entity; and receiving, via the connection, a real-time status of a position of a customer order in an order preparation queue of the food service entity. Depending on an implementation, a set of real-time conditions relating to a customer order may include, for example, a position of the customer order in a order preparation queue.

In an embodiment, providing, as input to a machine learning process, a set of properties associated with a customer order may include, for example, providing, at a first time, as input to the machine learning process, a first set of properties associated with the customer order; receiving, as output from the machine learning process, a first predicted lead time for providing the customer order as of the first time; providing, at a second (e.g., later, etc.) time, as input to the machine learning process, a second set of properties associated with the customer order; and receiving, as output from the machine learning process, a second predicted lead time for providing the customer order as of the second time. At times, one or more properties in the second set of properties may, for example, be similar to or may be different from one or more corresponding properties in the first set of properties.

In another aspect, one or more embodiments of the present disclosure feature a system for event prediction, such as illustrated in connection with predicting order preparation time using a machine learning process. A system may comprise a processor; and a memory storing computer-executable instructions for the processor to receive a set of properties for a corresponding plurality of historical customer orders associated with a food service entity; and train a machine learning process using the set of properties for the plurality of historical customer orders to predict a lead time for providing a new customer order associated with the food service entity. A set of properties for a historical customer order may include, for example, a set of characteristics of the historical customer order, a set of real-time conditions relating to the historical customer order, a lead time for providing the historical customer order, or the like.

In an embodiment, a food service entity may include, for example, a restaurant at a particular geographical location.

In an embodiment, a food service entity may include, for example, a plurality of restaurants of a particular brand at a plurality of different geographical locations.

In an embodiment, a set of characteristics of a historical customer order may include, for example, one or more types of items in the historical customer order and/or a number of items in the historical customer order, etc.

In an embodiment, a set of characteristics of a historical customer order may include, for example, one or more modifications to one or more items in the historical customer order and/or an indication of whether the historical customer order was scheduled for a future time, etc.

In an embodiment, a set of real-time conditions relating to a historical customer order may include, for example, a queue position of the historical customer order relative to one or more other historical customer orders.

In an embodiment, a set of real-time conditions relating to a historical customer order may include, for example, a location where the historical customer order was fulfilled, a day of the week of the historical customer order placement and/or fulfillment, a time of the historical customer order placement and/or fulfillment, weather conditions of the historical customer order placement and/or fulfilment, or the like.

In an embodiment, training a machine learning process may include, for example, providing at least a first portion of sets of properties for a plurality of historical customer orders as input to a gradient boosting algorithm.

In an embodiment, training a machine learning process may further include, for example, minimizing a mean squared error loss function.

In an embodiment, training a machine learning process may further include, for example, validating the machine learning process using at least a second (e.g., different, etc.) portion of one or more sets of properties for a plurality of historical customer orders.

In another aspect, one or more embodiments of the present disclosure feature a system for event prediction, such as implemented in the context of predicting order preparation time using a machine learning process. A system may comprise a processor; and a memory storing computer-executable instructions for the processor to receive a customer order for a food service entity; provide, as input to a machine learning process, a set of properties associated with the customer order, and receive, as output from the machine learning process, a predicted lead time for providing the customer order. A set of properties may include, for example, a set of characteristics of a customer order and a set of real-time conditions relating to the customer order. A machine learning process may, for example, be trained to predict lead times for providing customer orders associated with a food service entity using one or more characteristics of historical customer orders, real-time conditions relating to the historical customer orders, lead time for providing the historical customer orders, or the like.

In an embodiment, a system may further establish a connection to a customer order management system of a food service entity; and receive, via the connection, a real-time status of a position of a customer order in an order preparation queue of the food service entity. A set of real-time conditions relating to a customer order may include, for example, a position of a customer order in an order preparation queue.

In an embodiment, one or more operations to provide, as input to a machine learning process, a set of properties associated with a customer order may include, for example, one or more operations to provide, at a first time, as input to the machine learning process, a first set of properties associated with the customer order; receive, as output from the machine learning process, a first predicted lead time for providing the customer order as of the first time; provide, at a second (e.g., later, etc.) time, as input to the machine learning process, a second set of properties associated with the customer order; and receive, as output from the machine learning process, a second predicted lead time for providing the customer order as of the second time. One or more of these or like properties in the second set of properties may be similar to or may be different from one or more corresponding properties in the first set of properties.

### System Environment Overview

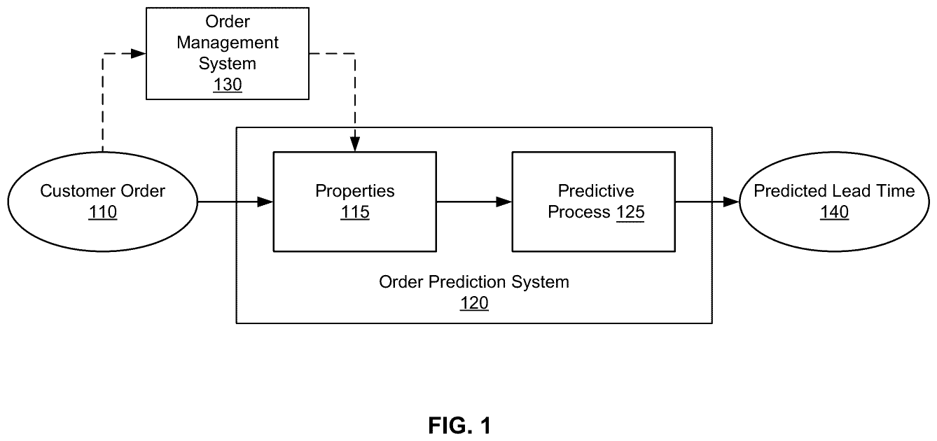

FIG. 1 illustrates an example system environment 100 for event prediction, such as implemented in the context of predicting order preparation time, for example, in accordance with an embodiment. System environment 100 may include, for example, an order prediction system 120. Order prediction system 120 may include software, hardware, and/or a combination thereof. Order prediction system 120 may be implemented, in whole or in part, with any suitable computing device, such as described throughout this disclosure, without limitation. In an embodiment, order prediction system 120 may be operable to run on a server, desktop, laptop, mobile application, and/or any other suitable computing device and/or environment. Order prediction system 120 may generate or otherwise output a predicted lead time 140 based, at least in part, on a customer order 110, as describe in greater detail below.

In an embodiment, system environment 100 may include, for example, an order management system 130. Order management system 130 may include software, hardware, and/or a combination thereof. In an embodiment, order management system 130 may operate remotely from order prediction system 120. For instance, and without limitation, order management system 130 may operate on a remote server, desktop, web application, or the like. In one or more other embodiments, order prediction system 120 may include, for example, order management system 130, without limitation. For instance, order management system 130 may be part of order prediction system 120. Order management system 130 may be in communication with order prediction system 120. For instance, and without limitation, order management system 130 may communicate with order prediction system 120 through the Internet, such as through one or more Wi-Fi signals and/or other suitable signals. Order management system 130 may, for example, be communicatively connected to order prediction system 120. As used in this disclosure, “communicatively connected” means connected by way of a connection, attachment, linkage, etc. between two or more relata, which may allow for reception and/or transmittance of electronic content or information therebetween. For example, and without limitation, this connection may be wired or wireless, direct, or indirect, between two or more components, circuits, devices, systems, or the like, which may allow for reception and/or transmittance of data and/or signal(s) therebetween. Data and/or signals therebetween may include, without limitation, electrical, electromagnetic, magnetic, video, audio, radio, microwave data and/or signals, combinations thereof, or the like, among others. A communicative connection may be achieved, for example and without limitation, through wired or wireless electronic, digital, or analog, communication, either directly or by way of one or more intervening devices or components, or any combination thereof. Further, communicative connection may include electrically coupling or connecting at least an output of one device, component, circuit, etc. to at least an input of another device, component, circuit, etc. For example, and without limitation, via a bus and/or other suitable facility for intercommunication between elements of one or more computing devices. In an embodiment, order management system 130 may be part of a third-party system. For instance, order management system 130 may be part of a restaurant or other entity's software infrastructure. Order prediction system 120 may integrate with an existing order management system 130 of a restaurant and/or any other suitable entity. As a non-limiting example, order prediction system 120 may communicate directly and/or indirectly with order management system 130, through an application programming interface (API), or the like.

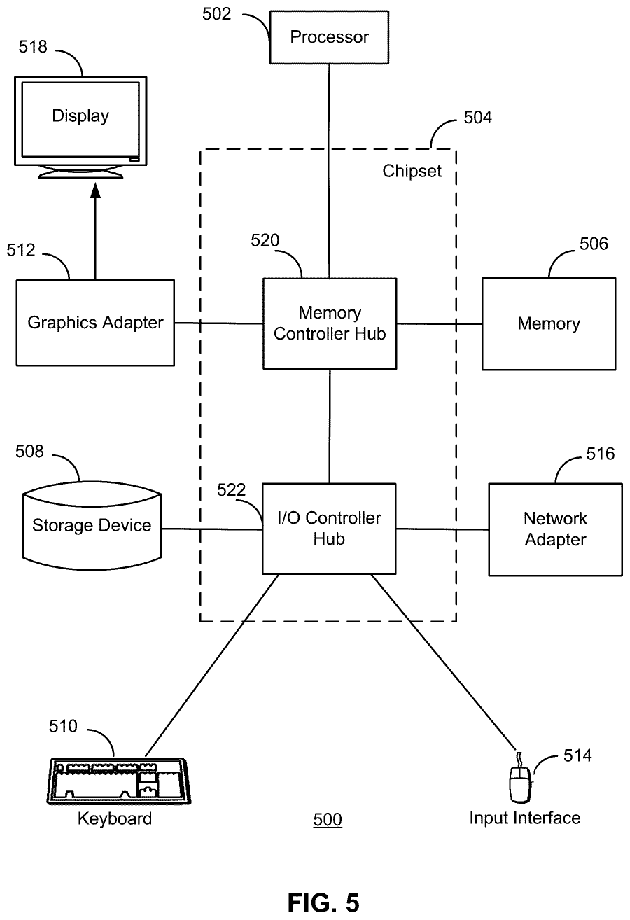

In an embodiment, order prediction system 120 may, for example, be operated by a single party (e.g., a service entity, a third party, etc.). In an embodiment, order prediction system 120 may, for example, be operated by a plurality of parties (e.g., both a service entity and the third party, etc.) In an embodiment, order prediction system 120 may connect or communicate with a customer, an internal platform (e.g., an order management platform operated by a service entity, etc.), an external platform (e.g., a web mapping platform, a weather forecasting platform, etc.), or the like to obtain input data associated with customer order 110. In particular embodiments, order prediction system 120 may be connected to an order management system 130, for example, to obtain information about a service entity and/or order, e.g., a queue position of the customer order relative to one or more other customer orders. In an embodiment, order prediction system 120 may include one or more computers and/or computing devices, such as, without limitation, a computer system 500, as discussed below with reference to FIG. 5.

In an implementation, order management system 130 may electronically receive one or more digital signals that may be representative of customer order 110. Thus, here, customer order 110 may also be referred to as a “digital request” interchangeably. Customer order 110 may include, but is not limited to, food types, food quantities, desired food preparedness times, or the like, just to name a few examples. Food types may include, for example, one or more dishes and/or meals, such as, without limitation, soups, sandwiches, steaks, or the like. Food quantities may include, for example, a number of one or more meals and/or dishes, such as one meal, two meals, or the like. Desired food preparedness times may include, for example, a requested time a meal may be completed. Customer order 110 may include one or more ingredients, preparing instructions, ingredient substitutions, or the like. Ingredients may include one or more parts of a dish, such as, but not limited to, breads, sauces, meats, vegetables, or the like. Preparing instructions may include specified requests such as a specific doneness of a steak, toasting a sandwich, cutting a wrap in half, or the like. Ingredient substitutions may include a request for swapping one or more ingredients for one or more other ingredients. For instance, pepper jack cheese instead of American cheese, red peppers instead of green peppers, English muffin instead of sourdough, or the like, without limitation. As a non-limiting example, customer order 110 may include a medium well done double cheeseburger without onions and with double cheese that should be ready by 6:30 PM EST.

Customer order 110 may further include an indication of delivery and/or pick up of customer order 110. For instance, customer order 110 may indicate that a user will pick up customer order 110 at a specific address, time, or the like. Customer order 110 may indicate that customer order 110 should be delivered to a specific address, at a specific time, or the like. Customer order 110 may include data associated with a service entity where customer order 110 is prepared, such as a brand of the service entity and/or a location of the service entity for example.

Customer order 110 may be received through, but not limited to, mobile applications, web portals, web browsers, self-service kiosks, etc. In an embodiment, order management system 130 may provide one or more options for customer order 110 to a user, such as through a graphical user interface (GUI). Order management system 130 may display though a GUI of a smartphone, laptop, tablet, or the like, one or more options of customer order 110 for a customer.

For instance, and without limitation, order management system 130 may provide a list of available items to order, restaurant locations, food preparation options, or the like. A user may enter customer order 110 through a GUI that may be suitably populated with applicable information from order management system 130. In an embodiment, customer order 110 may be provided from a user via an in-store visit. In an embodiment, customer order 110 may be a new customer order. In one or more other embodiments, customer order 110 may be a historical customer order, such as a historical customer order previously submitted from a user, for example.

In an embodiment, customer order 110 may, for example, be provided to a service entity (e.g., a food service entity, a clothing service entity, a cleaning service entity, a retail store, other service entity, etc.) for preparing customer order 110. Although customer order 110 has been described in the context of a restaurant, such as for ease of description, it should be appreciated that any other suitable customer order types may be implemented, in whole or in part, such as, but not limited to, dry-cleaning, house-cleaning, retail store orders, or the like. For instance, customer order 110 may include an order for a custom-made suit, grocery delivery, and/or other orders. One of ordinary skill in the art, upon reading this disclosure, will appreciate that various customer orders may be implemented herein.

Continuing with FIG. 1, order prediction system 120 may receive one or more properties 115 of customer order 110. In an embodiment, order prediction system 120 may receive one or more properties 115 of customer order 110 from order management system 130, such as through a wired, wireless, and/or other suitable connection. One or more properties 115 may include data such as, but not limited to, times, dates, food types, food instructions, requested completion times, customer identification, delivery addresses, pickup addresses, or the like. In an embodiment, order prediction system 120 may electronically receive and/or process a relatively high volume of customer orders over a period of time. For example, in an embodiment, order prediction system 120 may process at least 1, 5, 10, 50, 100, 200, 500, 1000, 2000, 5000 or more customer orders over a period of time that ranges from about 5 seconds to about 6 hours or more. In particular embodiments, order prediction system 120 may process, for example, at least 100 customer orders in 60 seconds. It should be noted that these are merely examples to which claimed subject matter should not be limited.

In an embodiment, one or more properties 115 may include, for example, about 1 to about 5000 properties 115 associated with customer order 110. One or more properties 115 may be associated with multiple customer orders. In an embodiment, one or more properties 115 may include 100 or more properties 115 associated with customer order 110, for example. In one or more particular embodiments, a set of one or more properties 115 may include, for example, more than 1000 properties 115 associated with customer order 110. In particular embodiments, one or more properties 115 associated with different customer orders may represent the same or substantially similar characteristic. For example, a plurality of properties 115 may include a plurality of geographical locations, where a particular geographical location of the plurality of geographical locations is associated with order 110 of a plurality of customer orders.

In an embodiment, one or more properties 115 may include, for example, at least a set of characteristics of customer order 110 and/or a set of real-time conditions relating to customer order 110. “Real-time” refers to one or more events happening at a present time. Real-time may include an instantaneous time, near-instantaneous time, or the like. For example, and without limitation, near-instantaneous time (which may be referred to as “near real-time”) may refer to events happening within seconds, milliseconds, microseconds, or the like, of an initial point in time. In an embodiment, one or more properties 115 may include one or more quantitative values associated with the properties of customer order 110.

In an embodiment, one or more properties 115 associated with customer order 110 may be identified that, taken individually or in combination, may be more predictive of order preparation time compared to one or more other properties associated with customer order 110. In some instances, individual properties 115 in a set of one or more properties 115 may, for example, be transformed into hundreds or thousands of properties 115. In an embodiment, one or more individual properties 115 in a set of one or more properties 115 may, for example, be transformed by forming various Boolean permutations of possible values of one or more properties. For purposes of illustration, and without limitation, a simple example of such a transformed feature may be a “(Phoenix=TRUE) AND (Boston=FALSE) AND (San Diego=FALSE)” for a feature identifying a restaurant with three possible locations. Other example transformations of the feature may then include “(Phoenix=FALSE) AND (Boston=TRUE) AND (San Diego=FALSE)” and “(Phoenix=FALSE) AND (Boston=FALSE) AND (San Diego=TRUE)”. Those of ordinary skill in the art, upon reading this disclosure, will appreciate the numerous manners in which large numbers of transformed properties can be created using Boolean-based and/or other suitable permutations of individual properties 115. The transformed properties 115 may subsequently be used, at least in part, to train a machine learning process, for example, and/or as input to a trained machine learning process, as described herein.

In an embodiment, a set of one or more properties 115 of customer order 110 may include, for example, one or more types of one or more items in customer order 110, a number of items in customer order 110, complexity in preparing the items, an indication of whether customer order 110 is requested to be prepared immediately or at a future date or time, or the like. These or like properties, alone or in any suitable combination with one or more other properties as described herein, may influence an order preparation order time. For example, and without limitation, it may take 10 minutes to prepare a burger or 5 minutes to prepare a salad. As another example, preparing a filet mignon may be more complex and lead to a longer lead time than preparing a salad. As yet another example, ordering a larger number of items may lead to a longer lead time than a smaller number of items of the same type. As yet another example, one or more modifications to an order may increase its lead time. Accordingly, a lead time for an entrée may vary between one entrée including a burger and another entrée that includes a salad.

In an implementation, order management system 130 may extract one or more properties 115 from customer order 110, for example. In one or more other embodiments, order prediction system 120 may receive multiple customer orders, for example, and may extract one or more properties 115 from multiple customer orders. One or more properties 115 of customer order 110 may include, without limitation, order type, items ordered, order complexity, expected order completion time, or the like. Extraction of one or more properties 115 from customer order 110 through order prediction system 120 and/or order management system 130 may include, for example, utilization of a language model processing, such as without limitation a natural language processing model. A language processing model may extract, from customer order 110, strings of one or more characters, including without limitation any sequence or sequences of letters, numbers, punctuation, diacritic marks, engineering symbols, geometric dimensioning and tolerancing (GD&T) symbols, chemical symbols and formulas, spaces, whitespace, and other symbols, including any symbols usable as textual data. Textual data generated from a language processing model may be parsed into tokens, which may include a simple word (sequence of letters separated by whitespace) or more generally a sequence of characters as described previously. The term “token,” as used herein, refers to any smaller, individual groupings of text from a larger source of text. Tokens may be broken up by word, pair of words, sentence, or other delimitation. These tokens may in turn be parsed in various ways. Textual data from a language processing model may be parsed into words or sequences of words, which may be considered words as well. Textual data may be parsed into “n-grams”, where all sequences of n consecutive characters are considered. Any or all possible sequences of tokens or words may be stored as “chains”, for example for use as a Markov chain or Hidden Markov Model. Any suitable language processing model may be used, in whole or in part, without limitation.

In an implementation, order prediction system 120 and/or order management system 130 may extract one or more characters, symbols, words, phrases, or the like from customer order 110. For instance, and without limitation, order prediction system 120 and/or order management system 130 may extract words, numbers, phrases, or the like such as “cheeseburger”, “2”, “medium well”, “5:15” or the like. Order prediction system 120 may associate one or more characters, strings, phrases, words, or the like with one or more meanings, categories, and/or other groupings. For instance, the word “cheeseburger” may be grouped to a dish type category of “American cuisine”, without limitation. Order prediction system 120 may utilize one or more language processing models, in whole or in part, to parse and/or group one or more properties 115.

In an embodiment, order prediction system 120 and/or order management system 130 may utilize a classifier, classification function, or the like. A “classifier,” as used in this disclosure, refers to a process, such as a machine-learning process, for example, which may include a specific application of a mathematical function, neural net, and/or program generated by a machine learning algorithm known as a “classification algorithm,” as described in further detail below, that sorts inputs into categories or bins of data, outputting the categories or bins of data and/or labels associated therewith. A classifier may output at least a datum that labels or otherwise identifies a set of data that are clustered together, found to be close under a distance metric as described below, or the like. Order prediction system 120 may generate a classifier using a classification algorithm, defined as a process in which a processor derives a classifier from training data. In one or more other embodiments, a pre-trained classifier may be communicated to order prediction system 120 from one or more external computing devices, such as, but not limited to, servers, laptops, desktops, or the like. Classification may be performed using, without limitation, linear classifiers such as without limitation logistic regression and/or naive Bayes classifiers, nearest neighbor classifiers such as k-nearest neighbors classifiers, support vector machines, least squares support vector machines, Fisher's linear discriminant, quadratic classifiers, decision trees, boosted trees, random forest classifiers, kernel estimation, learning vector quantization, and/or neural network-based classifiers.

For instance, order prediction system 120 and/or order management system 130 may utilize a classifier to categorize one or more properties 115 and/or customer order 110 to one or more categories. A classifier may be trained with training data with one or more properties 115 as inputs and one or more categories of the one or more properties 115 as outputs. Training data may be received through user input, external computing devices, and/or previous iterations of processing. Order prediction system 120 and/or order management system 130 may classify one or more words, phrases, or the like, which may be extracted from the properties to one or more categories. Categories may include, without limitation, lower complexity, medium complexity, higher complexity, or the like. A lower complexity category may include, for example, a grouping of one or more properties 115 of customer order 110 that may have relatively simple instructions, such as preparation of a peanut butter and jelly sandwich. A lower complexity category may correspond to a faster completion time. For instance, a lower complexity category may include a completion time of about 5 minutes to about 10 minutes, a time under 30 minutes, and/or other time frames, without limitation. In an embodiment, a medium complexity category may include a grouping of one or more properties 115 of customer order 110 that may have relatively average instructions. For instance, a ham and cheese sandwich on rye bread with lettuce and tomato may be categorized as a medium complexity category. A medium complexity category may correspond to an average completion time. An average completion time may include about 45 minutes, less than about 45 minutes, greater than about 45 minutes, or the like. A higher complexity category may include a grouping of one or more properties 115 of customer order 110 that may have relatively complex instructions. For instance, and without limitation, a dinner of pufferfish may be grouped to a higher complexity category. A higher complexity category may include a relatively high completion time, such as, but not limited to, about 1 hour, greater than 1 hour, or the like. Complexity categories may be user-entered, determined through one or more classifiers, or implemented via any other suitable approach.

In an embodiment, one or more categories of customer order 110 and/or one or more properties 115 may include dish specific categories. For instance, categories may include breakfast, lunch, dinner, snacks, deserts, appetizers, cocktails, or the like. In an embodiment, categories may include dish types, such as beef, chicken, fish, soup, sandwich, salad, or the like. A particular category may include a corresponding completion time. For instance, beef dishes may have an average completion time of about 45 minutes, while soup may have an average completion time of about 10 minutes. Order prediction system 120 may, for example, utilize one or more categories generated by a classifier as input to assist in generating predicted lead time 140. In an embodiment, order prediction system 120 may directly use one or more classifications of one or more properties 115 and/or customer order 110 to generate predicted lead time 140.

Still referring to FIG. 1, order prediction system 120 may utilize a predictive process 125 to generate one or more predicted lead times 140. Predictive process 125 may include any suitable machine learning process, which may include one or more processes described throughout this disclosure, without limitation. Predictive process 125 may, for example, be trained with training data correlating properties 115 and/or customer order 110 to one or more predicted lead times 140. Training data may be received through user input, external computing devices, and/or previous iterations of processing. Predictive process 125 may receive one or more properties 115 and output predicted lead time 140 or multiple predicted lead times 140. In particular embodiments, predictive process 125 may comprise machine learning process. In an embodiment, predictive process 125 may include and/or implement a gradient boosting algorithm. In particular embodiments, predictive process 125 may include or implement the extreme gradient boosting (XGBoost) algorithm, also referred to as an “extreme gradient boosting function” herein. In an embodiment, predictive process 125 may include or implement an algorithm from a machine learning library. In particular embodiments, predictive process 125 may include or implement an algorithm developed by an operator or a programmer using one or more programming languages (e.g., Python, Java, C++, Ruby, PHP, or any suitable programing languages). For example, a programmer may develop predictive process 125 by incorporating one or more custom algorithms and/or algorithms that may be included in generally available machine learning libraries.

In an embodiment, predictive process 125 may be generated, built, trained, and/or tested (e.g., during a training phase, etc.), in whole or in part, using one or more historical customer orders for providing event prediction (e.g., during a deployment phase, etc.) for new customer orders. In an embodiment, predictive process 125 may be trained by minimizing a loss function, such as mean squared error (MSE) using a training dataset, for example. In an embodiment, predictive process 125 may be evaluated and/or validated using a validation dataset. In one embodiment, predictive process 125 may train for multiple iterations on one or more subset of training data and/or validate on one or more other subsets of the training data, with training considered complete based, at least in part, on a threshold accuracy level. If suitable or desired, training data may be preprocessed to remove statistical outliers to reduce their impact on training the process.

In an embodiment, predictive process 125 may be selected from a plurality of predicted processes that may be built and trained. For instance, a plurality of predictive processes may be built and trained for specific scenarios such as, without limitation, brands of stores, cuisine types, specific towns, cities, and/or one or more other scenarios. In an embodiment, predictive process 125 may be tested using a testing dataset. In an embodiment, predictive process 125 may be tested by applying a validation method, such as k-fold cross-validation, where k refers to the number of folds. In particular embodiments, predictive process 125 may be validated by applying 3-fold cross-validation on the training data. In an embodiment, a regularization technique (e.g., early stopping) and/or an additional bias weight may be applied e.g., at the end of the training to increase an accuracy score of predictive process 125.

In an implementation, predictive process 125 and/or order prediction system 120 may generate predicted lead time 140. Predicted lead time 140 may be referred to as a “prediction event” interchangeably throughout this disclosure. Predicted lead time 140 may include, for example, a period of time associated with a preparation of customer order 110 to meet one or more expected completion times. In an embodiment, predicted lead time 140 may be indicative of a time to complete customer order 110, for example. Predicted lead time 140 may include any period of time, such as, but not limited to, about 5 minutes, greater than 5 minutes, or the like. In an embodiment, predicted lead time 140 may include, for example, a time ranging from about 1 second to about 12 hours or a longer time. In an embodiment, predicted lead time 140 may include, for example, a time of about 1 minute, about 5 minutes, about 10 minutes, about 15 minutes, about 20 minutes, about 25 minutes, about 30 minutes, about 1 hour, or more. In particular embodiments, predicted lead time 140 may be in a range from about 3 minutes to about 260 minutes. Order prediction system 120 may utilize, in whole or in part, one or more properties 115, such as, but not limited to, order modifications, order complexity, order quantity, time of day, time of week, restaurant location, or the like. One or more properties 115 may influence an order preparation time individually or in any suitable combination of properties. A combination of properties may influence an order preparation order time differently than if taken individually. Predicted lead time 140 may be communicated to kitchen staff or other entities, such as through order management system 130, without limitation. As a non-limiting example, predicted lead time 140 may include a time of about 15 minutes for mozzarella sticks, which may be communicated to a kitchen staff through order management system 130. Communication to a kitchen staff may include communicating predicted lead time 140 through wired, wireless, and/or any other suitable connections to one or more computing devices, such as, but not limited to, tablets, smartphones, desktops, laptops, or the like. Predicted lead time 140 may be presented through one or more GUIs, speakers, or the like. In an embodiment, an option to decline or update predicted lead time 140 presented to an entity, such as a kitchen, through order management system 130 may be presented. An entity may modify, cancel, and/or confirm predicted lead time 140. For instance and without limitation, an individual may provide user input such as through a keyboard, mouse, touchscreen, or other device, that may deny predicted lead time 140, add and/or subtract time from predicted lead time 140, or accept predicted lead time 140. Predictive process 125 may incorporate user input of a modification, cancellation, and/or confirmation of predicted lead time 140 into its training, which may improve future predicted lead time 140 generations.

For instance and without limitation, a cheeseburger of customer order 110 may take about 25 minutes to make based on one or more properties 115 of customer order 110. Predictive process 125 may output a predicted lead time 140 of about 25 minutes given one or more properties 115 of customer order 110. In an embodiment, one or more properties 115 of customer order 110 may include a queue position of customer order 110 relative to one or more other customer orders. A queue position of customer order 110 relative to one or more other customer orders may be obtained in real time from order management system 130 via a communicative coupling and/or other suitable connection (e.g., a network connection, etc.) between order prediction system 120 and order management system 130.

In an embodiment, obtaining a queue position of customer order 110 relative to one or more other customer orders may include order prediction system 120 being communicatively coupled to an order management system 130 (e.g., a restaurant's kitchen display system (KDS), etc.), as illustrated in FIG. 1. In an embodiment, a queue may be incremented while a new customer order is generated and provided to order management system 130. By way of example but not limitation, a queue may be incremented by 1 (one) while orders are sent or “fired” to a restaurant. As also defined below, in this context, the term “fire time” refers to time during which an order is sent to an order management system (e.g., to order management system 130, etc.). In an embodiment, a fire time may, for example, based, at least in part, on time to prepare a particular order. In another example, a queue may be decremented if preparation of an existing customer order is completed. By way of another non-limiting example, a queue may be decremented by 1 (one) upon receipt of a signal from an order management system that order preparation is completed. This is typically called the “order ready” event/time. A customer for an order may receive a notice of “order ready” indicating that customer order 110 is ready e.g., for pick up or for delivery. In an embodiment, a queue position of customer order 110 may be one of one or more properties 115 that may contribute to a prediction generated by predictive process 125. For instance, customer order 110 may have three different customer orders in front of a queue for preparation by one or more entities. Predictive process 125 may account for both complexity of customer order 110 and the position of customer order 110 in a queue, without limitation. Customer orders in a queue may have corresponding properties 115 that may alter predicted lead time 140 of these customer orders. As a non-limiting example, a queue of customer orders may include a first order of a ham and Swiss sandwich, a second order of a pufferfish dinner, and a third order of a chicken noodle soup. The ham and Swiss sandwich may have a lower complexity and lower completion time than the pufferfish dinner, but may have a higher complexity and a higher completion time than the chicken noodle soup. In an embodiment, to account for the higher complexity of the pufferfish dinner, order prediction system 120 may output predicted lead time 140 of about one hour for preparation of the chicken noodle soup. It should be noted that, in some implementations, a queue position may be indicative of a measure of “busyness” of a particular restaurant that may be used, in whole or in part, by an order prediction system, meaning that the queue position may or may not reflect where a particular order falls within the queue. For example, in some instances, a queue position of 10 may indicate that there are currently 10 orders in a queue, such as rather than indicating that a particular order is being placed 10th in the queue of 20 orders.

In an embodiment, a velocity may be one of one or more properties 115 of one or more customer orders. As used herein, “velocity” refers to an amount of customer orders that have been placed in a specific location over a specific period of time. A specific location may include, for instance and without limitation, one or more restaurants, tux rental stores, bowling alleys, and/or one or more other suitable locations. A specific period of time may include, but are not limited to, about 5 minutes to about 1 hour. In an embodiment, a period of time may be less than about 5 minutes or may be greater than about 1 hour. A velocity may be used, in whole or in part, instead of or in addition to one or more queue positions of one or more customer orders to generate predicted lead time 140. For instance, and without limitation, one or more properties 115 may include a velocity of about 25 customer orders over the course of 10 minutes at a specific restaurant. Order prediction system 120 may generate predicted lead time 140 to be about 40 minutes based, at least in part, on the velocity of the customer orders of the specific restaurant. In embodiments, order prediction system 120 may generate predicted lead time 140 to be shorter to account for a lower velocity of the customer orders of a specific location. In other embodiments, order prediction system 120 may generate predicted lead time 140 to be longer to account for a higher velocity of the customer orders of a specific location. A weight or influence of a velocity of a specific location on predicted lead time 140 may be selected by user input, calculated by order prediction system 120, and/or a combination thereof. In an embodiment, a weight or influence of a velocity of a specific location may be determined or calculated, in whole or in part, by a machine learning process, such as predictive process 125. Predictive process 125 may determine trends and/or patterns of velocity influence on predicted lead time 140. For instance, predictive process 125 may determine influence of a velocity of the customer orders for specific locations, times of day, location types, or the like. As a way of illustration, a velocity may be determined or calculated as the number of orders “fired” at a particular location within a certain period of time (e.g., in the last 30 minutes, etc.). Subsequently, this may be used, in whole or in part, by order prediction system 120 in predicting order preparation time for a particular order. It should be noted that, depending on an implementation, a velocity may or may not impact orders already in the queue. As another non-limiting example, predictive process 125 may determine a velocity may have less impact at a fast-food restaurant than at a suit rental store. In yet another non-limiting example, predictive process 125 may determine that a velocity of a specific restaurant may have less impact during morning operations than during evening operations of the specific restaurant.

In an implementation, prediction system 120 may implement one or more velocity thresholds of the customer orders for one or more locations. A velocity threshold may include one or more numerical values, or a any suitable combination thereof, that if exceeded may cause order prediction system 120 to increase predicted lead time 140. As a way of illustration, a velocity threshold may include, but is not limited to, 10 customer orders in 5 minutes, 50 customer orders in an hour, 20 customer orders in 15 minutes, and/or any other combination of amounts of customer orders over periods of time. Depending on an implementation, a velocity threshold may be determined dynamically and/or pre-defined based, at least in part, on one or more aspects, such as discussed herein. A velocity threshold may be inputted by a user and/or may be determined and/or generated by order prediction system 120. A velocity threshold may be based, in whole or in part, on a specific location, time of day, one or more properties 115 of the customer orders, or the like. For instance, a velocity threshold may be increased for a specific location at a nighttime and may be decreased for a specific location at a daytime. A velocity threshold may increase and/or decrease based, at least in part, on one or more properties 115 of the customer orders. For instance, one or more properties 115 of the customer orders may be relatively simple, such as an order for black coffee. In an embodiment, simpler properties 115 of the customer orders may be accounted for by order prediction system 120. Order prediction system 120 may generate higher velocity thresholds for simpler customer orders based, at least in part, on one or more properties 115 of the customer orders and/or may generate lower velocity thresholds for more complex customer orders based, at least in part, on one or more properties 115 of the customer orders. As a non-limiting example, a velocity threshold may be reduced based, at least in part, on one or more properties 115 of customer order 110 for a pufferfish dinner at a high-end restaurant due, at least in part, to the complexity of preparing a pufferfish dinner.

In an embodiment, predicted lead time 140 may include an order of preparation of two or more customer orders. For instance, continuing the example above, predicted lead time 140 may arrange an order of the pufferfish dinner first, the ham and Swiss second, and the chicken noodle soup last to account for these dishes complexity and completion time. In an embodiment, order prediction system 120 may account for a plurality of expected completion times and generate an arrangement of an order of preparation of multiple customer orders through predicted lead time 140. For instance, and without limitation, a first order may have properties 115 of a higher complexity but a later requested completion time than a second order that has properties 115 of a lower complexity and an early requested completion time. Order prediction system 120 may generate predicted lead time 140 to include the first order to be prepared initially and the second order to be prepared subsequently given the properties of the first and second orders.

In an embodiment, one or more properties 115 of customer order 110 may further include, for example, properties obtained from a service entity where customer order 110 is prepared. These one or more properties 115, alone or in combination with other properties as described herein, can influence an order preparation order time. For example, a brand that is busier than another brand, a location that is busier than another location on a particular day or time (e.g., Saturday evening), and/or a day that is busier than another day (e.g., busier on Saturdays compared to Mondays) may indicate a longer lead time for customer order 110. For instance, order prediction system 120 may account for one or more properties 115 such as a day of the week. As a non-limiting example, and without limitation, chicken parm may take about 35 minutes to make on a Monday afternoon, but about 55 minutes to make on a Friday night for a particular restaurant. In an embodiment, the time of day may also alter predicted lead time 140. For instance, continuing the above example, on a Monday afternoon chicken parm may take about 35 minutes to make but may take about 45 minutes to make on a Monday night.

In particular embodiments, one or more properties 115 of customer order 110 include properties associated with a brand of a service entity, a location of a particular brand of the service entity, and/or combinations thereof. For example, for a food service entity that includes a plurality of restaurants of a particular brand at a plurality of different geographical locations, one or more properties 115 associated with the food service entity may include a plurality of vendor identifiers (ID), where a particular vendor ID may represent a particular restaurant of the plurality of restaurants of a particular brand at a plurality of different geographical locations.

In an embodiment, one or more properties 115 may include a set of real-time conditions relating to customer order 110. In an embodiment, a set of real-time conditions relating to customer order 110 may include, for example, a location where a customer order was fulfilled, a day of the week of a customer order placement or fulfilment, a time of the customer order placement or fulfilment, weather conditions of the customer order placement or fulfilment, traffic conditions of the customer order placement or fulfilment. In an embodiment, at least part of the real-time conditions relating to customer order 110, such as weather or traffic conditions, may be obtained from one or more online mapping programs (e.g., Google Maps) or weather forecast programs.

In an embodiment, order prediction system 120 may account for one or more kitchen statuses. A kitchen status may include one or more customer orders currently being prepared, a queue of customer orders, a headcount of kitchen staff, or the like. Kitchen statuses may be communicated to order prediction system 120 through order management system 130. One or more kitchen statuses may include, for example, estimated preparation times for one or more dishes for specific kitchen staff. For instance, a first cook may take about 30 minutes to make a salmon steak, while a second cook may take about 45 minutes to make a salmon steak, even though customer order 110 of a salmon steak is the same. Order prediction system 120 may receive one or more kitchen statuses from order management system 130 and may input these into predictive process 125 to generate predicted lead time 140.

In an embodiment, predicted lead time 140 for a particular customer order may be updated based, at least in part, on a modification of customer order 110. For example, if the type or number of items of customer order 110, or an ingredient or portion of a standard item of customer order 110, is modified by a customer (whether before or after the order is first submitted) and provided to order prediction system 120, order prediction system 120 may analyze the modified data and generate an initial or new predicted lead time 140 associated with the modified customer order 110. In another example, if real-time conditions such as traffic or weather conditions change during the preparation of customer order 110, order prediction system 120 may analyze the changes of the real-time conditions and generate a new predicted lead time 140. In an embodiment, the output data generated by order prediction system 120 includes other predictions, such as predicted fire time, predicted lead time for pick up, predicted capacity of the service entity, predicted waiting time for obtaining a seat in a service entity, or the like.

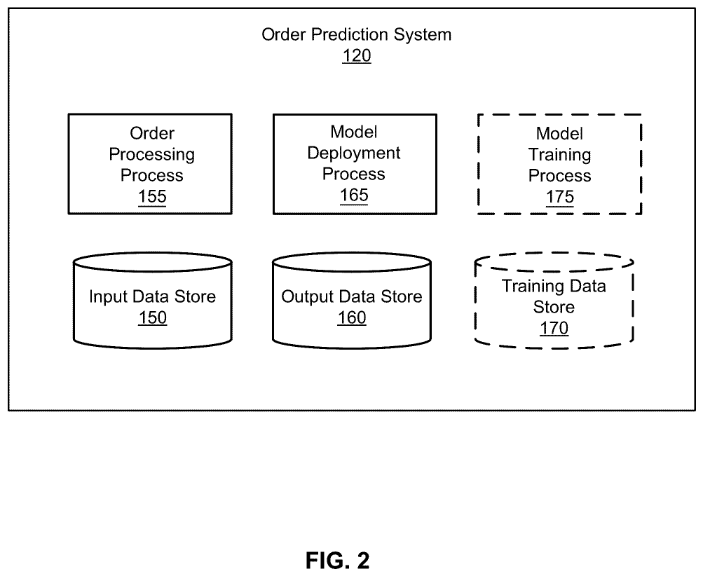

Reference is now made to FIG. 2, which illustrates an example block diagram illustrating computer logic components of order prediction system 120, in accordance with one or more embodiments, as described herein. In this particular implementation, components of order prediction system 120 are hereafter described in reference to two example phases: 1) a training phase and 2) a deployment phase. More specifically, the training phase refers to the building, training, and/or testing of predictive process 125 (e.g., a machine learning process) using applicable training data. Predictive process 125 can be trained such that during the deployment phase, implementation of the predictive process may generate a prediction (e.g., predicted lead time 140 in FIG. 1).

Referring still to FIG. 2, in an implementation, order prediction system 120 includes input data store 150, output data store 160, training data store 170, order processing process 155, predictive model deployment process 165, and visualization process 175.

In an embodiment, order prediction system 120 can include additional or fewer aspects and/or features. For example, the input data store 150 and/or the order processing process 155 may be optional to order prediction system 120. In another example, the model training process 175 and/or the training data store 170 may be optional to order prediction system 120. In an embodiment, the model training process 175 and/or the training data store 170 may be provided by another party or other system/service. In another example, an order prediction system 120 includes a visualization process (e.g., via a user interface) to facilitate and/or support presentation of the output data to a user (e.g., a user, a programmer, or an operator at a service entity) in a suitable manner.

The order processing process 155 can extract and/or process raw data associated with a customer order (e.g., customer order 110 in FIG. 1) that may be obtained from a customer, and provide a set of properties (e.g., one or more properties 115 in FIG. 1) associated with the customer order as input to the predictive model deployment process 165. The input data (e.g., raw data obtained from a customer, and/or the set of properties associated with the customer order) may be stored in the input data store 150.

The model deployment process 165 may deploy a predictive process (e.g., predictive process 125 in FIG. 1) to analyze input data (e.g., one or more properties 115 in FIG. 1) to generate output data (e.g., predicted lead time 140 in FIG. 1) for a customer order. The output data may be stored in the output data store 160.

The model training process 175 may train a predictive process (e.g., predictive process 125 in FIG. 1) to analyze training data (e.g., training data associated with historical customer orders) to generate predictions for a new customer order. The training data may be stored in the training data store 170.

In an embodiment, the components of order prediction system 120 can be performed by different parties depending on whether the components are applied during the training phase or the deployment phase. In such scenarios, the training and deployment of the prediction process may be performed by different parties. For example, the model training process 175 and training data store 170 can be employed by a first party during the training phase. In another example, the model deployment process 165 and input data store 150 can be employed by a second party during the deployment phase. In another example, the order processing process 155 and input data store 150 can be employed by a third party during the training phase and/or the deployment phase. In another example, the output data store 160 can be employed by a fourth party.

### Methods for Generating Predictions Using Machine Learning Process

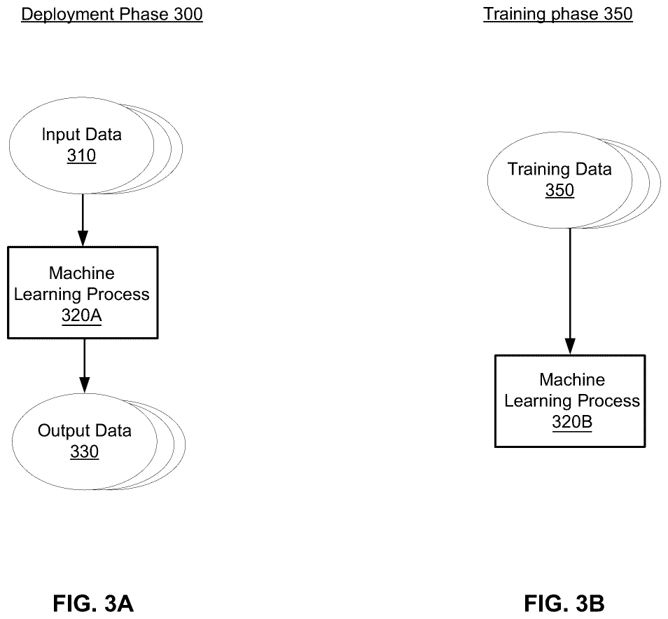

Referring now to FIG. 3A, a deployment phase 300 of the machine learning process 320A is illustrated, according to an implementation. During the deployment phase 300, at least a subset of properties (e.g., properties 115 in FIG. 1) can be considered as input data 310 by the machine learning process 320A. The machine learning process 320A may receive the input data 310, which may include properties as described above with reference to FIG. 1, for example, and may generate output data 330, which may include one or more predicted lead times described above with reference to FIG. 1. In an embodiment, a subset of properties may be used, in whole or in part, as the input data 310. A subset of properties may include properties that may have been determined (e.g., during the training phase 350) to be the most predictive of accurate lead times for the service entity. In an embodiment, the subset of properties may differ (e.g., may be determined on a case-by-case basis) among service entities such that the predictive process trained for a particular service entity can generate a more accurate prediction specific to the particular service entity. For example, modification of order may be a property that is more predictive of lead time for a first service entity (e.g., one restaurant brand) but less predictive of lead time for a second service entity (e.g., a different restaurant brand). Thus, modification of order may be considered by a predictive process more useful for the second service entity.

In an embodiment, the input data 310 may be obtained from a customer, an internal platform (e.g., an order management platform operated by a service entity), and/or an external platform (e.g., a web mapping platform, a weather forecasting platform). In an embodiment, the input data 310 includes a set of properties for one or more customer orders (e.g., properties 115 in FIG. 1). In an embodiment, the input data 310 may be obtained from the input data store 150 or other databases as described above with reference to FIG. 2. In an embodiment, the input data 310 is available to a party such as a service entity. In an embodiment, the input data 310 is available to multiple parties such as a plurality of food service entities (e.g., a chain restaurant using the same online ordering system). In an embodiment, the machine learning process 320A has been trained using training data 350.

In an embodiment, the output data 330 includes a predicted lead time for providing the customer order, such as predicted lead time 140 as described above with reference to FIG. 1. In an embodiment, the output data 330 includes additional information such as the top 1, top 2, top 3, top 4, top 5, top 6, top 7, top 8, top 9, or top 10 or more properties that most heavily contributed to the prediction. For instance, a particular property of a customer order may be assigned a weighted value, such as from 0 to 1, out of 100, or the like. Assignment of weighted values of one or more properties may be received through user input and/or from the machine learning process 320A. For instance, a weight of 0.2 may be applied to property of a modification of a customer order, a weight of 0.4 may be applied to a property of a relative complexity of a customer order, and a weight of 0.4 may be applied to a property of a position in a queue of the customer order. In an embodiment, an optimization function may be used, in whole or in part, to minimize a predicted lead time given a set of properties. The machine learning process 320A, through iterations of training and/or deployment, may update and assign various weights to one or more properties of one or more customer orders. In an embodiment, the output data 330 is stored in the output data store 160, as described above with reference to FIG. 2. In an embodiment the machine learning process 320A may have been trained using training data, e.g., historical customer orders and their associated preparation times. In an embodiment, the input data 310 and/or output data 330 are displayed to a user, using e.g., an user interface.

Referring now to FIG. 3B, a training phase 350 of the machine learning process 320B is shown. The machine learning process 320B may be the same as that of the machine learning process 320A as described above with reference to FIG. 3A. The training phase 350 refers to the building, training, and/or testing of the machine learning process 320B, which may be predictive process 125 as described above with reference to FIG. 1, using training data. The machine learning process 320B may be trained such that, during the deployment phase 300 described above, implementation of the machine learning process 320B may enable a generation of a prediction (e.g., predicted lead time 140 in FIG. 1).

In general, during the training phase 350, a plurality of different machine learning process 320B or the same machine learning process 320B may be trained for a particular service entity by brand, by location, and/or by any suitable other characteristics. Thus, the impact of the brand, location, or other properties, individually or in combination, can be learned and/or determined by the machine learning process 320B.

In an embodiment, the machine learning process 320B may be any one of a regression process (e.g., linear regression, logistic regression, or polynomial regression), decision tree, random forest, gradient boosted machine learning process, support vector machine, Naïve Bayes model, k-means cluster, or neural network (e.g., feed-forward networks, convolutional neural networks (CNN), deep neural networks (DNN), autoencoder neural networks, generative adversarial networks, or recurrent networks (e.g., long short-term memory networks (LSTM), bi-directional recurrent networks, deep bi-directional recurrent networks), or any combination thereof.

The machine learning process 320B may be trained using a machine learning implemented method, such as any one of a linear regression algorithm, logistic regression algorithm, decision tree algorithm, support vector machine classification, Naïve Bayes classification, K-Nearest Neighbor classification, random forest algorithm, deep learning algorithm, gradient boosting algorithm, and dimensionality reduction techniques such as manifold learning, principal component analysis, factor analysis, autoencoder regularization, and independent component analysis, or combinations thereof. In an embodiment, the machine learning implemented method may be a logistic regression algorithm, random forest algorithm, gradient boosting algorithm such as XGboost, or the like. In an embodiment, the machine learning process 320B may be trained using supervised learning algorithms, unsupervised learning algorithms, semi-supervised learning algorithms (e.g., partial supervision), weak supervision, transfer, multi-task learning, and/or any combination thereof.

In an embodiment, the machine learning process 320B may have one or more parameters, such as hyperparameters and/or model parameters. Hyperparameters may be established prior to training. Examples of hyperparameters include, without limitation, learning rate, depth or leaves of a decision tree, number of hidden layers in a deep neural network, number of clusters in a k-means cluster, penalty in a regression process, a regularization parameter associated with a cost function, or the like. Process parameters may be adjusted during training. Examples of process parameters include, without limitation, weights associated with nodes in layers of neural network, support vectors in a support vector machine, node values in a decision tree, and coefficients in a regression process. The process parameters of the order prediction process are trained (e.g., adjusted) using the training data to improve the predictive capacity of the machine learning process.

In an embodiment, the training data 330 is split into a training dataset, a validation dataset, and/or a testing dataset. In an embodiment, the training data 330 undergoes a 50:25:25 training: validation: testing dataset split ratio. In an embodiment, the training data 330 undergoes a 60:20:20 training: validation: testing dataset split ratio. In an embodiment, the training data 330 undergoes a 80:10:10 training: validation: testing dataset split ratio.

In an embodiment, the training data 330 is split to a training dataset and/or a testing dataset. In an embodiment, the training data 330 undergoes a 50:50 training: testing dataset split ratio. In an embodiment, the training data 330 undergoes a 60:40 training: testing dataset split ratio. In an embodiment, the training data 330 undergoes a 80:20 training: testing dataset split ratio.

In an embodiment, the machine learning process 320B is trained by implementing a gradient boosting algorithm, such as the extreme gradient boosting (XGBoost) algorithm. In an embodiment, the machine learning process 320B is trained using the training data (e.g., training data 350) to minimize a loss function (e.g., mean squared root) such that the process can better predict the outcome (e.g., predicted lead time 140 in FIG. 1) based on the input (e.g., properties 115 in FIG. 1).

In an embodiment, the performance of the machine learning process 320B is tested by applying a validation method, such as k-fold (e.g., 3-fold) cross-validation. In an embodiment, a regularization technique (e.g., early stopping) and/or an additional bias weight are applied to increase an accuracy score indicating the accuracy of the output.

In an embodiment, the machine learning process 320B is trained using a training dataset. In an embodiment, the machine learning process 320B is validated using a validation dataset. In an embodiment, the performance of the machine learning process 320B is tested using a testing dataset.

In an embodiment, the machine learning process 320B may identify or determine relative impact of one or more properties on predictions. In an embodiment, the top 1 to top 10 properties with a largest impact on predictions are determined. In an embodiment, the trained machine learning process includes a set of trained parameters such that while the machine learning process 320A is deployed, the set of trained parameters are used, in whole or in part, by the machine learning process 320A to weigh properties that have larger impact on predictions more heavily than other properties. In an embodiment, the relative impact of the one or more properties on predictions are determined by using Shapley values to explain the output of the machine learning process 320A or 320B.

In an embodiment, the properties with the largest impact on predictions (e.g., highly predictive of accurate lead time) for one service entity are different as compared to another service entity. Thus, determining the top properties with a largest impact on predictions can improve the accuracy of predictions generated by the predictive process for a specific service entity.

In an embodiment, the machine learning process 320B may consider over 1000 individual features of a customer order e.g., at the time of the placement of an order.

In an embodiment, the training data 350 may be pre-processed, e.g., using an order processing process 155, to generate a set of properties as input values for training a machine learning process 320B.

In an embodiment, the training data 350 includes sets of properties (e.g., properties 115 in FIG. 1) for a plurality of historical customer orders.

In an embodiment, the training data 350 includes a subset of properties. In an embodiment, the subset of properties include the top 1, 5, 10 or more properties with a largest impact on predictions (e.g., predictive of more accurate lead time) for a service entity (e.g., the service entity where the process is implemented). In an embodiment, the subset of properties may differ for a service entity as compared to another service entity.

In an embodiment, the training data 350 further includes lead time associated with historical customer orders. In an embodiment, the training data 350 may be obtained from the training data store 170 or other databases, such as described above with reference to FIG. 2.

In an embodiment, the training data 350 is associated with one party such as a food service entity (e.g., a restaurant at a particular geographical location). In an embodiment, the training data 350 is associated with multiple parties, such as a plurality of food service entities (e.g., a plurality of restaurants of a particular brand at a plurality of geographical locations using the same online ordering system).

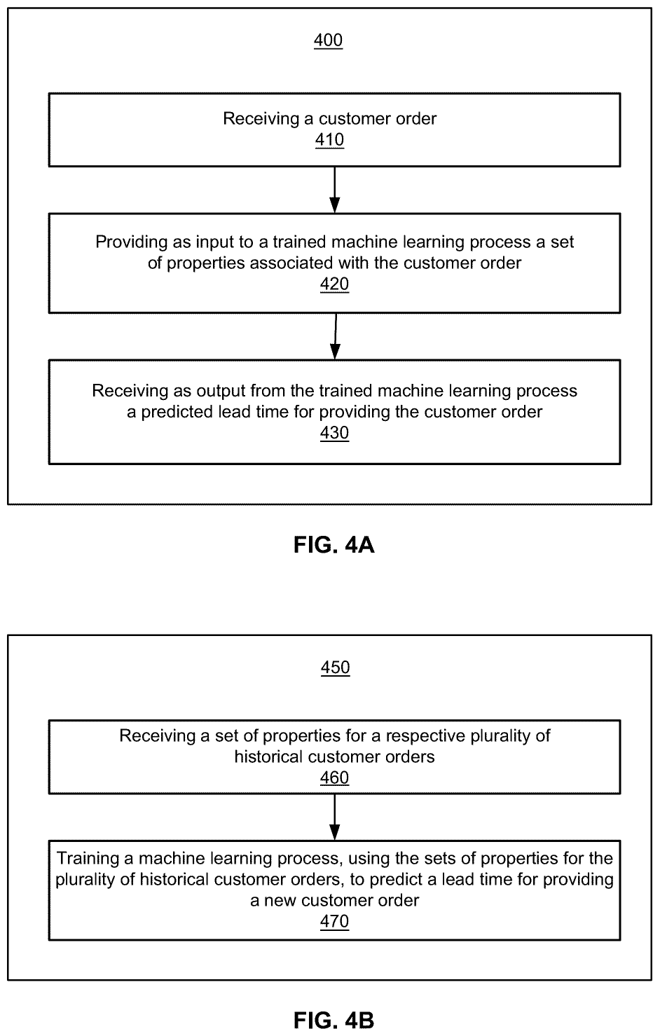

FIG. 4A illustrates a flow process 400 for deploying a machine learning process, in accordance with some embodiments, as described herein. In some cases, the machine leaning process implemented in the deployment phase has been trained in a training phase. This step may be implanted, without limitation, as described above with reference to FIGS. 1-3B.

At step 410, a customer order is received. In an embodiment, the customer order is an online order. In some cases, the machine leaning process implemented in the deployment phase has been trained in a training phase. This step may be implemented, without limitation, as described above with reference to FIGS. 1-3B.

At step 420, a set of properties associated with the customer order is provided as input to a trained machine learning process. In some cases, the machine leaning process implemented in the deployment phase has been trained in a training phase. This step may be implemented, without limitation, as described above with reference to FIGS. 1-3B.

At step 430, a predicted lead time for providing the customer order is received as output from the from the trained machine learning process. In some cases, the machine leaning process implemented in the deployment phase has been trained in a training phase. This step may be implemented, without limitation, as described above with reference to FIGS. 1-3B.

In an embodiment, the customer order may be modified by the customer, and thus a new set of properties of the customer order is generated. Accordingly, steps 410, 420, and 430 are repeated to generate a modified lead time based on the modified customer order.

Additionally and optionally, steps 420 and 430 can be repeatedly performed for generating an updated lead time during the preparation of the customer order.

FIG. 4B illustrates a flow process 450 for developing a machine learning process, in accordance with some embodiments, as described herein.

At step 460, in an embodiment, a set of properties for a respective plurality of historical customer orders is received as input data for training the machine learning process. In an embodiment, a set of properties for some of a plurality of historical customer orders is received as input data for training the machine learning process.

At step 470, a machine learning process is trained using the sets of properties for the plurality of historical customer orders, to predict a lead time for providing a new customer order.

In an embodiment, steps 460 and 470 can be repeatedly performed for generating a trained machine learning process with high accuracy and/or efficiency.

### Thresholds

In an embodiment, systems and methods as described herein include or implement a threshold to cap in-progress orders (e.g., orders that are under preparation). In an embodiment, the threshold to cap in-progress orders is represented by a maximum number for in-progress orders associated with a service entity at a specific time. Thus, once the number of in-progress orders of a service entity reaches the threshold, additional orders may be held for providing to the service entity until the service entity has capacity (e.g., until the number of in-progress orders is less than the threshold). Such threshold can be beneficial for managing capacity of a service entity by configuring the number of in-progress orders during a period of time (e.g., periods of peak traffic), resulting in an efficient flow of orders to the service entity associated with the orders (e.g., kitchen of the restaurant). In an embodiment, the number of in-progress orders at a specific time may be equal to or less than the threshold (e.g., 2 orders, 3 orders, 5 orders, 10 orders or more) to cap in-progress orders. In an embodiment, the threshold to cap in-progress orders is pre-determined.

In an embodiment, the threshold to cap in-progress orders is interfaced with the machine learning process as described herein for generating predictions. For example, if a customer places an order to a restaurant if the number of in-progress orders associated with the restaurant has reached the threshold, the lead time of the customer's order may include both the order preparation time and the fire time (e.g., the time to wait for sending the order to the restaurant if the number of in-progress orders is less than the threshold).

In an embodiment, systems and methods as described herein include or implement a total lead time threshold (e.g., 30 minutes, 60 minutes or a longer time) for orders that are to be prepared immediately. For example, if the total lead time threshold is 60 minutes, and a new order is predicted to be ready in excess of the total lead time threshold, a message may be sent to the customer stating that the service entity is experiencing high order volume and cannot immediately start the order.

In an embodiment, systems and methods as described herein can evaluate whether a desired time window selected by a customer is available. If a desired time window is not available, a message may be sent to the customer stating that the service entity is experiencing high order volume and cannot prepare the customer's order within the desired time window.

In an embodiment, systems and methods as described herein may optionally implement a threshold to cap in-progress orders and/or a total lead time threshold.

In an embodiment, the methods for generating predictions for a customer order as described herein include activating and/or implementing a threshold to cap in-progress orders and/or a total lead time threshold.

In an embodiment, the methods for generating predictions for a customer order as described herein include de-activating a threshold to cap in-progress orders and/or a total lead time threshold.

### Computer Implementation

The methods and systems as described herein can be performed on one or more special purpose computing devices, such as computing devices programmed with specific computer-readable instructions to facilitate and/or support one or more implementations of one or more operations and/or techniques described herein.

For example, the development and/or deployment of machine learning process as described herein can be implemented in hardware, software, and/or a combination of both. In an embodiment, a machine-readable storage medium is provided, the medium comprising a data storage material encoded with machine readable data which, while using a machine programmed with instructions for using said data, is capable of executing the training or deployment of machine learning process and/or displaying any of the datasets or results described herein. The machine learning process as described herein can be implemented in computer programs executing on programmable computers, comprising a processor, a data storage system (including volatile and non-volatile memory and/or storage elements), a graphics adapter, a pointing device, a network adapter, at least one input device, and at least one output device. A display is coupled to the graphics adapter. Program code is applied to input data to perform the functions described above and generate output information. The output information is applied to one or more output devices, in known fashion. The computer can be, for example, a personal computer, microcomputer, or workstation of conventional design.

Program(s) can be implemented in a high-level procedural or object-oriented programming language to communicate with a computer system. However, the programs can be implemented in assembly or machine language, if desired. In any case, the language can be a compiled or interpreted language. A computer program is preferably stored on a storage media or device (e.g., ROM or magnetic diskette) readable by a general or special purpose programmable computer, for configuring and operating the computer while the storage media or device is read by the computer to perform the procedures described herein. The system can also be considered to be implemented as a computer-readable storage medium, with a host computer program, where the storage medium causes a computer to operate in a specific and predefined manner to perform the functions described herein.

The data used in connection with the present disclosure can be recorded on computer readable media, e.g. any medium that can be read and accessed directly by a computer. Such media include, but are not limited to: magnetic storage media, such as floppy discs, hard disc storage medium, and magnetic tape; optical storage media such as CD-ROM; electrical storage media such as RAM and ROM; and hybrids of these categories such as magnetic/optical storage media. One of skill in the art can readily appreciate how any of the presently known computer readable mediums can be used to create a manufacture comprising a recording of the present database information. Any convenient data storage structure can be chosen, based on the means used to access the stored information. A variety of data processor programs and formats can be used for storage, e.g. word processing text file, database format, etc.

Processors suitable for the execution of the systems and methods in the presently disclosed embodiments include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. One or more memories can store media assets (e.g., audio, video, graphics, interface elements, and/or other media files), configuration files, and/or instructions that, upon execution by a processor, form the process, engines, and other components described herein and perform the functionality associated with the components. The processor and the memory can be supplemented by, or incorporated in special purpose logic circuitry.

It should also be noted that the present implementations can be provided as one or more computer-readable programs embodied on or in one or more articles of manufacture. The article of manufacture can be any suitable hardware apparatus, such as, for example, a floppy disk, a hard disk, a CD-ROM, a CD-RW, a CD-R, a DVD-ROM, a DVD-RW, a DVD-R, a flash memory card, a PROM, a RAM, a ROM, or a magnetic tape. In general, the computer-readable programs can be implemented in any programming language. The software programs can be further translated into machine language or virtual machine instructions and stored in a program file in that form. The program file can then be stored on or in one or more of the articles of manufacture.

In an embodiment, the systems and methods as described herein are performed on one or more computers in a distributed computing system environment (e.g., in a cloud computing environment). In this description, “cloud computing” is defined as a process for enabling on-demand network access to a shared set of configurable computing resources. Cloud computing can be employed to offer on-demand access to the shared set of configurable computing resources. The shared set of configurable computing resources can be rapidly provisioned via virtualization and released with low management effort or service provider interaction, and then scaled accordingly. A cloud-computing process can be composed of various characteristics such as, for example, on-demand self-service, broad network access, resource pooling, rapid elasticity, measured service, and so forth. A cloud-computing process can also expose various service processes, such as, for example, Software as a Service (“SaaS”), Platform as a Service (“PaaS”), and Infrastructure as a Service (“IaaS”). A cloud-computing e can also be deployed using different deployment process such as private cloud, community cloud, public cloud, hybrid cloud, and so forth. In this description and in the claims, a “cloud-computing environment” is an environment in which cloud computing is employed.

Examples of a computing device include a personal computer, desktop computer laptop, server computer, a computing node within a cluster, message processors, hand-held devices, multi-processor systems, microprocessor-based or programmable consumer electronics, network PCs, minicomputers, mainframe computers, mobile telephones, PDAs, tablets, pagers, routers, switches, or the like.

FIG. 5 illustrates an example computer for implementing the systems and methods as described herein, according to am implementation. In an embodiment, the computing device includes at least one processor 502 coupled to a chipset 504. The chipset 504 includes a memory controller hub 520 and an input/output (I/O) controller hub 522. A memory 506 and a graphics adapter 512 are coupled to the memory controller hub 520, and a display 518 is coupled to the graphics adapter 512. A storage device 508, an input interface 514, and network adapter 516 are coupled to the I/O controller hub 522. Other embodiments of the computing device have different architectures.

The storage device 508 is a non-transitory computer-readable storage medium such as a hard drive, compact disk read-only memory (CD-ROM), DVD, or a solid-state memory device. The memory 506 holds instructions and data used by the processor 502. The input interface 514 is a touch-screen interface, a mouse, track ball, or other type of input interface, a keyboard, or some combination thereof, and is used to input data into the computing device. In an embodiment, the computing device may receive input (e.g., commands) from the input interface 514 via gestures from the user. The graphics adapter 512 displays images and other information on the display 518. The network adapter 516 couples the computing device to one or more computer networks.

The graphics adapter 512 displays representations, graphs, tables, and other information on the display 518. In various embodiments, the display 518 may be implemented such that the user (e.g., data scientists, data owners, data partners) may input user selections on the display 518. In one embodiment, the display 518 may include a touch interface. In various embodiments, the display 518 can show one or more predicted lead time for providing a customer order.

The computing device 500 is adapted to execute computer program or process for providing functionality described herein. As used herein, the term “process” refers to computer program logic used to provide the specified functionality. Thus, a process can be implemented in hardware, firmware, and/or software. In one embodiment, program are stored on the storage device 508, loaded into the memory 506, and executed by the processor 502.

The types of computing devices 500 can vary from the embodiments described herein. For example, order prediction system 120 can run in a single computer 500 or multiple computers 500 communicating with one or more other computing devices via a network such as in a server farm. In another example, the computing device 500 can lack some of the components described above, such as graphics adapters 512, input interface 514, and displays 518.

### EXAMPLES

### Example 1: Example Order Management System

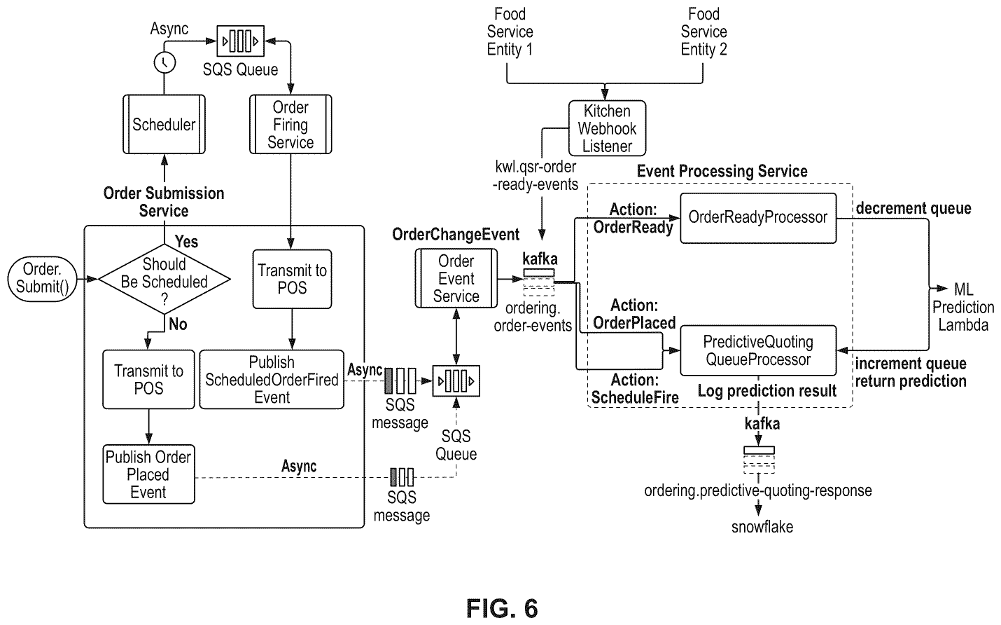

FIG. 6 depicts an example order management system, in accordance with a particular non-limiting implementation. The online ordering platform included a plurality of process such as “Order Submission Service”, “Event Processing Service”, scheduler service, order firing service, order event service, kitchen webhook listener, and/or one or more simple queue service (SQS) queue units.

In some cases, the “Order Submission Service” process receives input data associated with one or more submitted orders (“Order. Submit” in FIG. 6), and provides output data (e.g., “SQS message” in FIG. 6) to a “SQS queue” unit in communication with the “Order Event Service” unit (e.g., order change event). The “Order Submission Service” includes point of sale system (POS) and queue service systems (e.g., Kafka, RabbitMQ, Amazon SQS etc). The orders generated may be provided to the event processing service process as input, for generating output to provide to the machine learning process.

In some cases, the “Event Processing Service” process receives input from 1) the order event service process, and/or the order status information from the kitchen webhook listener of the restaurant(s). The input data includes three actions: order ready, order placed, and schedule/fire. Input data associated with order ready is provided as input to the order ready processor, for generating an output to decrement queue. Input data associated with order placed or schedule filer is provided as input to the predictive quoting queue processor. The predictive quoting queue processor receives additional input associated with incremented queue return prediction, and generates prediction results as a final output.

### Example 2: Example Process Training and Prediction Performance

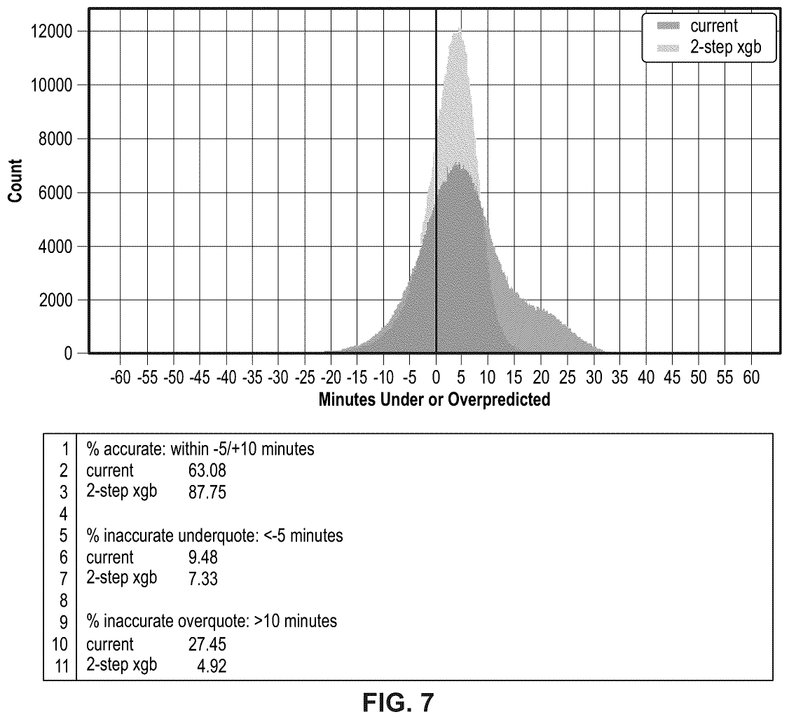

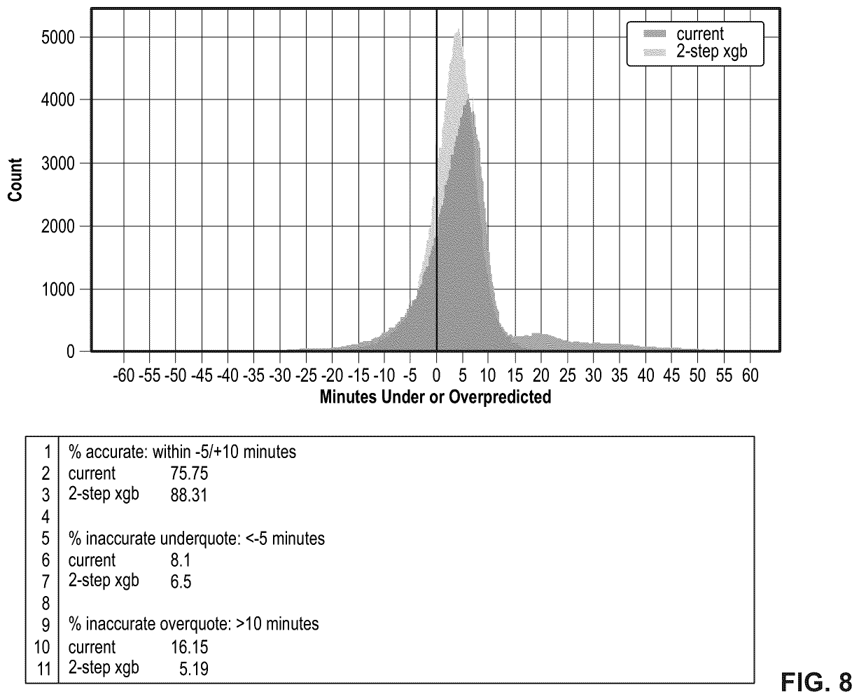

FIGS. 7 and 8 illustrate performance of trained machine learning processes in predicting order preparation time associated with two example food service entities, such as implemented in connection with one or more simulations and/or experiments.

In FIGS. 7 and 8, the y-axis represents counts or number of orders involved in the implementation of the process(s), and the x-axis represents minutes underpredicted or overpredicted by the machine learning process as compared with the real lead time. The results by implementing embodiments of methods and systems as described herein are represented by the curve of “2-step xgb”. The results by applying existing quoting and/or ordering platform are represented by the curve of “current”.

The accuracy of the prediction is characterized by values of the following example parameters: 1) percentage of orders that were underpredicted within (e.g., equal to and less than) 5 minutes or overpredicted within 10 minutes (“within −5/+10 minutes” in FIGS. 7 and 8), represented by the area under the curve in the range of −5≤x≤10, over total counts; 2) percentage of orders that were underpredicted over 5 minutes (“<−5 minutes” in FIGS. 7 and 8), represented by the area under the curve in the range of x<−5, over total counts; 3) percentage of orders that were overpredicted over 10 minutes (“>10 minutes” in FIGS. 7 and 8), represented by the area under the curve in the range of x>10, over total counts.

For the first food entity service, as shown in FIG. 7, the percentage of orders “within −5/+10 minutes” over total counts is about 87.75% by implementing embodiments of methods and systems as described herein, which increases from about 63.08% by applying existing quoting and/or ordering platform. Accordingly, the “2-step xgb” method in this example demonstrated an improved accuracy of (87.75−63.08)/63.08=39.1% for providing a predicted lead time that is underpredicted within (e.g., equal to and less than) 5 minutes or overpredicted within 10 minutes.

For the first food entity service, as shown in FIG. 7, the percentage of orders “<−5 minutes” over total counts was about 7.33% by implementing embodiments of methods and systems as described herein, from about 9.48% by applying existing quoting and/or ordering platform.

For the first food entity service, as shown in FIG. 7, the percentage of orders “>10 minutes” over total counts was about 4.92% by implementing embodiments of methods and systems as described herein, from about 27.45% by applying existing quoting and/or ordering platform.

For the second food entity service, as shown in FIG. 8, the percentage of orders “within −5/+10 minutes” over total counts was about 88.31% by implementing embodiments of methods and systems as described herein, which increased from about 75.75% by applying existing quoting and/or ordering platform. Accordingly, the “2-step xgb” method in this example demonstrated an improved accuracy of (88.31−75.75)/75.75=16.6% for providing a predicted lead time that is underpredicted within (e.g., equal to and less than) 5 minutes or overpredicted within 10 minutes.

For the second food entity service, as shown in FIG. 8, the percentage of orders “<−5 minutes” over total counts was about 6.5% by implementing embodiments of methods and systems as described herein, from about 8.1% by applying existing quoting and/or ordering platform.

For the second food entity service, as shown in FIG. 8, the percentage of orders “>10 minutes” over total counts was about 5.19% by implementing embodiments of methods and systems as described herein, from about 16.15% by applying existing quoting and/or ordering platform.

Altogether, the predictive process as described herein (e.g., “2-step xgb” in FIGS. 7 and 8) demonstrated improved performance in predicting lead time, such as in comparison against traditional methods (“current” in FIGS. 7 and 8).

### Definitions

Terms used in the claims and specification are defined as set forth below unless otherwise specified.

The term “customer order” refers to an order that is generated by a customer. In an embodiment, a customer order is an online order generated by a customer using a computing device, which may include a mobile device, for example, through an online platform (e.g., a webpage, a software, or a mobile application). In an embodiment, the online platform includes an interface that allows customers to view the menu and place an order. In an embodiment, the online platform includes an interface that enables the order service entity (e.g., a restaurant) to receive and/or prepare the customer orders.

The term “lead time” refers to the amount of time between placement of an order (e.g., by a customer, etc.) and receipt of the product associated with the order, such as captured via one or more electronic communications. In an embodiment, the order is an online order. In particular embodiments, the online order is associated with a food service entity such as a restaurant. In an embodiment, the lead time is exchangeable with “order preparation time” or similar terms. In an embodiment, the online order is generated by a customer. In an embodiment, the generated online order is modified by a different or the same customer.

The term “fire time” refers to the time during which an order is sent to an order management system. In an embodiment, a fire time may be based, at least in part, on the time to prepare the order.

The term “historical customer order” refers to a customer order that was previously received, processed, and completed by a service entity.

The term “machine learning library” refer to a collection of pre-written code that can be used in a program to perform a specific task or set of tasks in programming. In an embodiment, a machine learning library includes software that provides tools and functions for building, training, or deploying machine learning process. In an embodiment, a machine learning library may be provided as a way for programmers to reuse code that has already been written and tested, so as to not having to write all of the code from scratch. Example machine learning libraries as described herein may include NumPy, Matplotlib, Pandas, Scikit-Learn, TensorFlow, PyTorch, and/or Keras.

The terms “data,” “content,” “information” and similar terms may be used interchangeably to refer to data capable of being captured, transmitted, received, manipulated, displayed and/or stored in accordance with various examples.

The terms “about” or “substantially” that modify a condition or relationship characteristic of a feature or features of an embodiment of the disclosure, are to be understood to mean that the condition or characteristic is defined to within tolerances that are acceptable for operation of the embodiment for an application for which it is intended. For example, the terms “about,” “substantially,” and/or “close” with respect to a magnitude or a numerical value may imply to be within an inclusive range of −10% to +10% of the respective magnitude or value.

It must be noted that, as used in the specification, the singular forms “a,” “an” and “the” include plural referents unless the context clearly dictates otherwise. By way of example, “an analogue” means one analogue or more than one analogue.

A numerical value presented herein is contemplated to represent a minimum value or a maximum value in a range for a corresponding parameter. Accordingly, in the claims, the numerical value provides express support for claiming the range, which may lie above or below the numerical value, in accordance with the teachings herein. A particular value between the minimum value and the maximum value within a numerical range presented herein (including in the figures), is contemplated and expressly supported herein, subject to the number of significant digits expressed in a particular range. Absent express inclusion in the claims, a numerical value presented herein is not to be considered limiting in any regard.

Having described certain embodiments of the disclosure, it will be apparent to those of ordinary skill in the art that other embodiments incorporating the concepts disclosed herein may be used without departing from the spirit and scope of the disclosure. Accordingly, the described embodiments are to be considered in all respects as only illustrative and not restrictive. The terms and expressions employed herein are used as terms and expressions of description and not of limitation and there is no intention, in the use of such terms and expressions, of excluding any equivalents of the features shown and described or portions thereof. The structural features and functions of the various embodiments may be arranged in various combinations and permutations, and all are considered to be within the scope of the disclosure. Unless otherwise necessitated, recited steps in the various methods may be performed in any order and certain steps may be performed substantially simultaneously and/or in parallel.

What is claimed is:

1. A method of event prediction using a predictive process, the method comprising:
receiving, at a computing device, a digital request from an order management system of an entity;
obtaining, by the computing device, a property of the digital request, wherein the property includes a time to complete the digital request;
inputting, by the computing device, the property into the predictive process, the predictive process utilizing, at least in part, an extreme gradient boosting function, wherein the predictive process is trained to input properties and output prediction events through at least an iteration of a training phase of the extreme gradient boosting function; and
generating, from the predictive process, a prediction event including a period of time, wherein the prediction event is indicative of a time to complete the digital request.

2. The method of claim 1, wherein the property includes a queue position of the digital request.

3. The method of claim 1, wherein receiving the digital request further comprises receiving the digital request at the order management system of the entity from a smartphone of a user.

4. The method of claim 1, wherein the entity is a food service entity.

5. The method of claim 1, and further comprising:
receiving, at the computing device, a real-time condition; and
updating, by the predictive process, the prediction event based, at least in part, on the real-time condition.

6. The method of claim 5, wherein the real-time condition includes at least traffic data.

7. The method of claim 1, and further comprising:
classifying, by a classifier, the digital request to a complexity category; and
generating, based at least in part by the complexity category, the prediction event.

8. The method of claim 1, wherein the property includes at least one of the following: a time of day; a time of week; or a combination thereof.

9. The method of claim 1, and further comprising:
providing, at a first time, as input to the predictive process a first set of properties of the digital request;
receiving, as output from the predictive process, a first prediction event for providing the digital request as of the first time;
providing, at a second time, as input to the predictive process, a second set of properties of the digital request, wherein one or more properties in the second set of properties is different from one or more corresponding properties in the first set of properties; and
receiving, as output from the predictive process, a second prediction event for providing the digital request as of the second time.

10. The method of claim 1, and further comprising making available the prediction event for displaying through a display device.

11. An order prediction system, comprising:
a processor; and
a memory communicatively coupled to the processor, the memory having instructions for the processor to:
receive a digital request from an order management system of an entity;
obtain a property from the digital request, wherein the property includes a time to complete the digital request;
input the property into a predictive process, the predictive process programmed to utilize an extreme gradient boosting function, wherein the predictive process is trained to input one or more properties and output one or more prediction events through at least an iteration of a training phase of the extreme gradient boosting function; and
generate a prediction event based, at least in part, on the predictive process, wherein the prediction event is indicative of a time to complete the digital request.

12. The system of claim 11, wherein the property includes a queue position of the digital request.

13. The system of claim 11, wherein the order management system of an entity receives the digital request from a smartphone of a user and communicates the digital request to the processor.

14. The system of claim 11, wherein the order management system is in communication with a food service entity.

15. The system of claim 11, wherein the processor further:
receives a real-time condition; and
updates the prediction event based, at least in part, on the real-time condition through the predictive process, at least in part.

16. The system of claim 15, wherein the real-time condition includes at least traffic data.

17. The system of claim 11, wherein the processor further:
classifies the digital request to a complexity category via a classifier; and
generates, based at least in part on the complexity category, the prediction event.

18. The system of claim 11, wherein the property includes at least one or the following: a time of day; a time of week; or a combination thereof.

19. The system of claim 11, wherein the processor further calculates a ranked list of properties of the digital request in order of impact on the prediction event.

20. A non-transitory computer readable medium storing instructions that, upon execution by a processor, cause the processor to:
receive a set of properties for a plurality of historical customer orders associated with a food service entity, wherein the set of properties comprises a set of characteristics of a particular historical customer order of the plurality of historical customer orders, a set of real-time conditions relating to the historical customer order, and a lead time for providing the historical customer order; and
train a machine learning process, using the set of properties, to predict a lead time for providing a new customer order associated with the food service entity.
